(19) United States
(12) Patent Application Publication
(10) Pub. No.: US 2025/0104131 A1
(43) Pub. Date: Mar. 27, 2025

(54) SYSTEM, METHOD AND COMPUTER PROGRAM FOR MANAGING INFORMATION IN MARKETPLACE

(71) Applicants: Ramachandran PADMANABHA RAO, Indore (IN); Bhaskar SHARMA, Indore (IN); Avikshit SARAS, Indore (IN)

(72) Inventors: Ramachandran PADMANABHA RAO, Indore (IN); Bhaskar SHARMA, Indore (IN); Avikshit SARAS, Indore (IN)

(21) Appl. No.: 18/020,363

(22) PCT Filed: Jan. 9, 2023
(86) PCT No.: PCT/US2023/010385

§ 371 Date: Feb. 8, 2023

(51) Int. Cl. G06Q 30/0601

(52) U.S. Cl. CPC G06Q 30/0641; G06Q 30/0623

(57) ABSTRACT

Provided are apparatus, system, method, and device for managing information in a marketplace. The apparatus includes: at least one memory storage storing computer-executable instructions; and at least one processor communicatively coupled to the memory storage, wherein the at least one processor may be configured to execute the computer-executable instructions to: present, to a user, a first graphical user interface (GUI) comprising information associated with a service; receive, via the first GUI, a user input for obtaining further information associated with the service; and present, to the user, a second GUI comprising the further information associated with the service.

### BACKGROUND

### 1. Field

Apparatuses, systems and methods consistent with example embodiments of the present disclosure relate to a marketplace, more particularly, to managing information in the marketplace.

### 2. Description of Related Art

Traditionally, telecommunication systems have been mainly hardware-based, and telecommunication services were mainly provided in the form of hardware and were usually proprietary or managed by a specific vendor, a service provider, and/or a network operator. Recently, the evolvement of telecommunication technologies enables the telecommunication services to be provided in the form of software. For instance, the telecommunication network services can be defined and provided in software-based form or virtual network services, such as Virtualized Network Functions (VNFs) or Software Defined Networking (SDN), among others.

Accordingly, provision and management of telecommunication services are no longer proprietary by a limited vendor(s). For example, multiple vendors may provide similar telecommunication services by deploying the associated services in a software-based marketplace, and the users (e.g., network operator, enterprise users, personal users, etc.) may choose appropriate vendor or service provider according to their own requirement.

Nevertheless, disaggregation in services provision and services management, which results in significant increase of options and choices of vendors or service providers, may causes difficulty for the users in understanding, planning, deciding, and/or selecting which vendor(s) or service provider(s) is the best fit for their purpose or business plan. Accordingly, in the related art, in order to understand more about the provider of a service, the users may need to manually look for the information of the provider, before making a decision (e.g., decision in purchasing/subscribing a service, decision to switch to another service provider, etc.).

The aforesaid approach in the related art, however, may be inefficient and ineffective, due to the following reasons.

To begin with, there may have a significant amount of information resources available, some of which may contain non-accurate information (e.g., outdated information, etc.) and/or non-reliable information (e.g., unverified information, etc.). Thus, it may be challenging for the user to quickly obtain the accurate and reliable information. In this regard, an inexperienced user may obtain non-accurate information and/or non-reliable information, and may be misled by said information when making a decision.

Further, the information required by the users may be scattered among multiple information resources, and the users may need to have multiple attempts to access the information resources so as to obtain the required information therefrom. Said approach may be inefficient and burdensome for the user, particularly when the user would like to obtain update for multiple information frequently. For instance, whenever the user would like to check and obtain one or more updated information, the user may need to again access the multiple information resources to manually collect the desired information therefrom.

Furthermore, information which are provided by different information resources may be in different formats. For instance, the computer-readable format of the provided information may be different, and the user may need to review the provided information in different ways (e.g., online web browsing, installing an application on a device to access the information, etc.). In addition, the presentation style of an information may be different across different information resources, thus it may be challenging for the user to have a stable user experience particularly when the user would like to obtain an information from multiple resources to verify the accuracy and reliability of the information, to obtain from an information resource an update of an information obtained from another information resource, and the like.

### SUMMARY

Example embodiments of the present disclosure provide an apparatus, a system and a method for effectively and efficiently managing and presenting information to a user. Ultimately, example embodiments of the present disclosure improve user experience, reduce user's burden, and simplify the decision making process.

According to embodiments, an apparatus including: at least one memory storage storing computer-executable instructions; and at least one processor communicatively coupled to the memory storage, wherein the at least one processor may be configured to execute the computer-executable instructions to: present, to a user, a first graphical user interface (GUI) comprising information associated with a service; receive, via the first GUI, a user input for obtaining further information associated with the service; and present, to the user, a second GUI comprising the further information associated with the service.

The further information associated with the service may include information of a provider of the service. The first GUI may include an interactive element, and wherein the user input may include a user interaction with the interactive element. The second GUI may include a plurality of block elements, each of which may include a category of information associated with the provider.

The at least one processor may be configured to execute the computer-executable instructions to present the second GUI by: selecting a plurality of information resources; obtaining one or more information from the plurality of information resources; and generating the second GUI based on the one or more information.

The at least one processor may be configured to execute the computer-executable instructions to select the plurality of information resources by: determining a plurality of available information resources; and selecting, from the plurality of available information resources, a plurality of optimal information resources.

The at least one processor may be configured to execute the computer-executable instructions to obtain the one or more information by: generating, based on the type of the plurality of information resources, one or more requests; providing the one or more requests to the plurality of information resources; and obtaining, from the plurality of information resources, the one or more information.

The at least one processor may be configured to execute the computer-executable instructions to generate the second GUI by: obtaining a configuration profile defining the configuration of the second GUI; obtaining, based on the configuration profile, one or more information required for generating the second GUI; and generating, based on the configuration profile and the one or more information required, the second GUI.

According to embodiments, a method, performed by at least one processor, including: presenting, to a user, a first graphical user interface (GUI) comprising information associated with a service; receiving, via the first GUI, a user input for obtaining further information associated with the service; and presenting, to the user, a second GUI comprising the further information associated with the service.

The further information associated with the service may include information of a provider of the service. The first GUI may include an interactive element, and wherein the user input may include a user interaction with the interactive element. The second GUI may include a plurality of block elements, each of which may include a category of information associated with the provider.

The presenting the second GUI may include: selecting a plurality of information resources; obtaining one or more information from the plurality of information resources; and generating the second GUI based on the one or more information.

The selecting the plurality of information resources may include: determining a plurality of available information resources; and selecting, from the plurality of available information resources, a plurality of optimal information resources.

The obtaining the one or more information may include: generating, based on the type of the plurality of information resources, one or more requests; providing the one or more requests to the plurality of information resources; and obtaining, from the plurality of information resources, the one or more information.

The generating the second GUI comprises: obtaining a configuration profile defining the configuration of the second GUI; obtaining, based on the configuration profile, one or more information required for generating the second GUI; and generating, based on the configuration profile and the one or more information required, the second GUI.

According to embodiments, a non-transitory computer-readable recording medium having recorded thereon instructions executable by at least one processor to cause the at least one processor to perform a method including: presenting, to a user, a first graphical user interface (GUI) comprising information associated with a service; receiving, via the first GUI, a user input for obtaining further information associated with the service; and presenting, to the user, a second GUI comprising the further information associated with the service. The further information associated with the service may include information of a provider of the service. The first GUI may include an interactive element, and wherein the user input may include a user interaction with the interactive element. The second GUI may include a plurality of block elements, each of which may include a category of information associated with the provider.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 illustrates a diagram of an example general system architecture, according to one or more embodiments;

FIG. 2 illustrates an example system of a marketplace platform, according to one or more embodiments;

FIG. 3 illustrates an example block diagram of system modules for managing information associated with a service, according to one or more embodiments;

FIG. 4 illustrates an example flow diagram of a method for managing information, according to one or more embodiments;

FIG. 5 illustrates an example of a first graphical user interface (GUI), according to one and more embodiments;

FIG. 6 illustrates an example of a second GUI, according to one and more embodiments;

FIG. 7 illustrates an example flow diagram of a method for generating an information GUI, according to one or more embodiments;

FIG. 8 illustrates an example flow diagram of a method for selecting one or more information resources, according to one or more embodiments;

FIG. 9 illustrates a flow diagram of a method for obtaining one or more information, according to one or more embodiments;

FIG. 10 illustrates a flow diagram of a method for generating the information GUI based on the obtained one or more information, according to one or more embodiments;

FIG. 11 is a diagram of an example environment in which systems and/or methods, described herein, may be implemented; and

FIG. 12 is a diagram of example components of a device, according to one or more embodiments.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

In one implementation of the disclosure described herein, a display page may include information residing in the computing device's memory, which may be transmitted from the computing device over a network to a database center and vice versa. The information may be stored in memory at each of the computing device, a data storage resided at the edge of the network, or on the servers at the database centers. A computing device or mobile device may receive non-transitory computer readable media, which may contain instructions, logic, data, or code that may be stored in persistent or temporary memory of the mobile device, or may somehow affect or initiate action by a mobile device. Similarly, one or more servers may communicate with one or more mobile devices across a network, and may transmit computer files residing in memory. The network, for example, can include the Internet, wireless communication network, or any other network for connecting one or more mobile devices to one or more servers.

Any discussion of a computing or mobile device may also apply to any type of networked device, including but not limited to mobile devices and phones such as cellular phones (e.g., any “smart phone”), a personal computer, server computer, or laptop computer; personal digital assistants (PDAs); a roaming device, such as a network-connected roaming device; a wireless device such as a wireless email device or other device capable of communicating wireless with a computer network; or any other type of network device that may communicate over a network and handle electronic transactions. Any discussion of any mobile device mentioned may also apply to other devices, such as devices including short-range ultra-high frequency (UHF) device, near-field communication (NFC), infrared (IR), and Wi-Fi functionality, among others.

Phrases and terms similar to “software”, “application”, “app”, and “firmware” may include any non-transitory computer readable medium storing thereon a program, which when executed by a computer, causes the computer to perform a method, function, or control operation.

Phrases and terms similar to “network” may include one or more data links that enable the transport of electronic data between computer systems and/or modules. When information is transferred or provided over a network or another communications connection (either hardwired, wireless, or a combination of hardwired or wireless) to a computer, the computer uses that connection as a computer-readable medium. Thus, by way of example, and not limitation, computer-readable media can also include a network or data links which can be used to carry or store desired program code means in the form of computer-executable instructions or data structures and which can be accessed by a general purpose or special purpose computer.

Phrases and terms similar to “portal” or “terminal” may include an intranet page, internet page, locally residing software or application, mobile device graphical user interface, or digital presentation for a user. The portal may also be any graphical user interface for accessing various modules, components, features, options, and/or attributes of the disclosure described herein. For example, the portal can be a web page accessed with a web browser, mobile device application, or any application or software residing on a computing device.

Phrases and terms similar to “marketplace”, “marketplace platform”, “marketplace system”, or “marketplace module” may refer to a system through which a plurality of users may provide, receive, and/or utilize one or more services.

Phrases and terms similar to “products” or “services” may include a product, a service, an application, which may be virtualized/defined in software-form and may be deployed via the marketplace. Further, while example embodiments may refer to telecommunications related products and services, it is understood that the disclosure is not limited thereto and the marketplace may be for telecommunications and/or non-telecommunications related products. For example, the marketplace may provide applications and services for business enterprises in general (e.g., customer service-related applications, inventory management applications, financial forecasting or planning applications, accounting applications, etc.).

Phrases and terms similar to “provider” or “vendor” may include a person or a group of people who are able to provide one or more services to a user via the marketplace. For instance, a “service provider” may be a network operator, an operator of the marketplace, a vendor, a personal developer, and the like. Further, phrases and terms similar to “system admin” or “admin user” may include a person or a group of people who are managing and/or operating the marketplace.

In addition, although the example embodiments described herein may refer to management of information of service provider, it can be understood that one or more features described herein may also be applicable to management of other type of information. For instance, one or more features described herein may be similarly applied in managing information of a physical product, a non-telco related service, and the like, and may be similarly applicable in other sector or technical field, such as in managing company portfolio in financial sector, and the like.

Example embodiments of the present disclosure provide a system and method for effectively and efficiently managing and presenting information to a user. According to embodiments, system and method of the present disclosure may dynamically determine one or more optimal information resources and obtain updated information therefrom in real-time or near real-time. Ultimately, example embodiments of the present disclosure improve user experience, reduce user's burden, and simplify the decision making process.

### Marketplace Systems and Modules

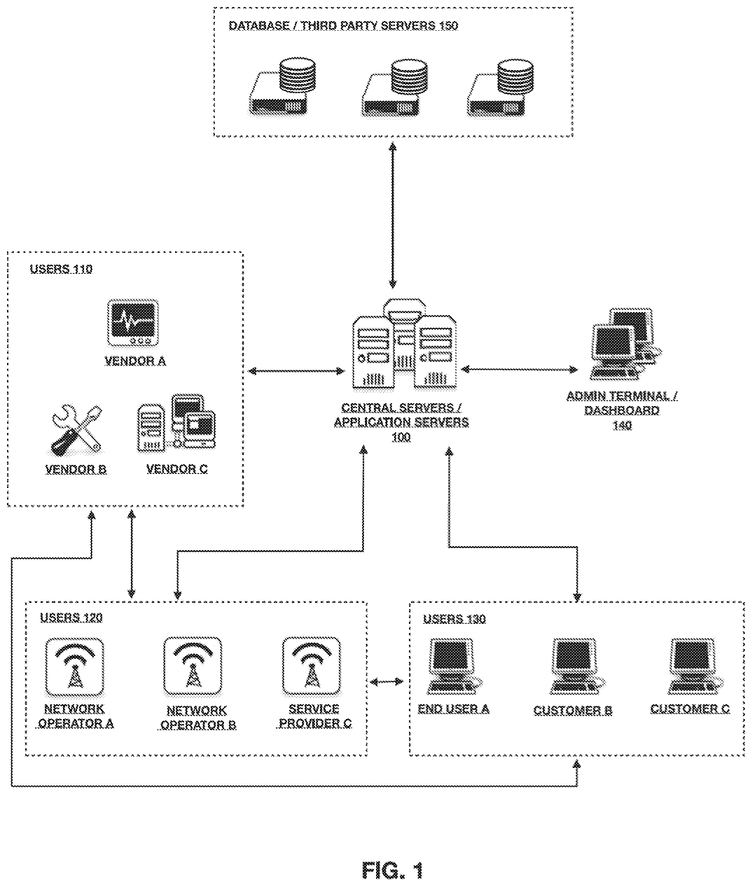

FIG. 1 illustrates a diagram of an example general system architecture, according to one or more embodiments. Referring to FIG. 1, users 110, 120, and 130 can be in bi-directional communication over a network with central servers or application servers 100 according to one or more embodiments. In addition, users 110, 120, 130 may also be in direct bi-directional communication with each other via the marketplace platform network system according to one or more embodiments. Here, users 110 can be any type of vendor, service provider, or developer, such as vendors A, B, and C, offering to users 120 and/or users 130 similar, same, or different services or products with respect to a network or service operator. In particular, users 110 can provide any type of telecommunication and/or non-telecommunication service or product, such as cellular service network deployment, network capacity update, operational monitoring, data analytics and reporting, performance analysis, and any other suitable services. Each of users 110 can communicate with servers 100 via their respective terminals or portals. Users 120 can be network operators A and B and service provider C, which may offer similar, same, or different services or products to users 130 and/or users 110. Here, users 110 and/or 120 can be any type of vendor or network service provider, network operator, carrier, broadband provider, Unified Communications as a Service (UCaaS) providers, wired or wireless cellular network service provider, radio access network (RAN), web host, or any network or telecommunications related service or network provider, among others. Each of users 120 can communicate with servers 100 via their respective terminals or portals. Users 130 can be any type of end user or customer of users 120 and/or users 110, such as end user A or customers B and C, or the end user purchasing and/or receiving the services of users 110 and/or users 120. Each of users 130 can communicate with servers 100 via their respective terminals or portals.

Still referring to FIG. 1, central servers 100 of the marketplace platform system according to one or more embodiments can be in further bi-directional communication with admin terminal/dashboard 140. Here, admin terminal/dashboard 140 can provide various tools to any of users 110, 120, and 130, or a sales team or a content/product creation team to manage various customers/end users and customer leads, wherein such managing can include, among others, creating, editing, and promoting various types of services or product sales promotional campaigns, advertising, offerings, and ordering options for customers and other users of the marketplace platform according to one or more embodiments. In addition, admin terminal/dashboard 140 may also include various types of access privileges to different users of the marketplace platform system according to one or more embodiments. Further, central servers 100 according to one or more embodiments can be in further bi-directional communication with database/third party servers 150. Here, servers 150 can provide various types of data storage (such as cloud-based storage), web services, content creation tools, data streams, data feeds, and/or provide various types of third-party support services to central servers 100 of the marketplace platform. However, it is contemplated within the scope of the present disclosure described herein that the network services marketplace platform process and system according to one or more embodiments can include any type of general network architecture.

Still referring to FIG. 1, one or more servers or terminals of elements 100-150 may include a personal computer (PC), a printed circuit board comprising a computing device, a mini-computer, a mainframe computer, a microcomputer, a telephonic computing device, a wired/wireless computing device (e.g., a smartphone, a personal digital assistant (PDA)), a laptop, a tablet, a smart device, a wearable device, or any other similar functioning device.

In some embodiments, as shown in FIG. 1, one or more servers, terminals, and users 100-150 may include a set of components, such as (but are not limited to) a processor, a memory, a storage component, an input component, an output component, a communication interface, and a JSON UI rendering component. The set of components of the device may be communicatively coupled via a bus.

The bus may comprise one or more components that permit communication among the set of components of one or more of servers or terminals of elements 100-150. For example, the bus may be a communication bus, a cross-over bar, a network, or the like. The bus may be implemented using single or multiple (two or more) connections between the set of components of one or more of servers or terminals of elements 100-150. The disclosure is not limited in this regard.

One or more servers or terminals of elements 100-150 may comprise one or more processors. The one or more processors may be implemented in hardware, firmware, and/or a combination of hardware and software. For example, the one or more processors may comprise a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), a general purpose single-chip or multi-chip processor, or other programmable logic device, discrete gate or transistor logic, discrete hardware components, or any combination thereof designed to perform the functions described herein. A general purpose processor may be a microprocessor, or any conventional processor, controller, microcontroller, or state machine. The one or more processors also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

The one or more processors may control overall operation of one or more of servers or terminals of elements 100-150 and/or of the set of components of one or more of servers or terminals of elements 100-150 (e.g., memory, storage component, input component, output component, communication interface, rendering component).

One or more of servers or terminals of elements 100-150 may further comprise memory. In some embodiments, the memory may comprise a random access memory (RAM), a read only memory (ROM), an electrically erasable programmable ROM (EEPROM), a flash memory, a magnetic memory, an optical memory, and/or another type of dynamic or static storage device. The memory may store information and/or instructions for use (e.g., execution) by the processor.

A storage component of one or more of servers or terminals of elements 100-150 may store information and/or computer-readable instructions and/or code related to the operation and use of one or more of servers or terminals of elements 100-150. For example, the storage component may include a hard disk (e.g., a magnetic disk, an optical disk, a magneto-optic disk, and/or a solid state disk), a compact disc (CD), a digital versatile disc (DVD), a universal serial bus (USB) flash drive, a Personal Computer Memory Card International Association (PCMCIA) card, a floppy disk, a cartridge, a magnetic tape, and/or another type of non-transitory computer-readable medium, along with a corresponding drive.

One or more of servers or terminals of elements 100-150 may further comprise an input component. The input component may include one or more components that permit one or more of servers and terminals 100-150 to receive information, such as via user input (e.g., a touch screen, a keyboard, a keypad, a mouse, a stylus, a button, a switch, a microphone, a camera, and the like). Alternatively or additionally, the input component may include a sensor for sensing information (e.g., a global positioning system (GPS) component, an accelerometer, a gyroscope, an actuator, and the like).

Further, one or more of servers or terminals of elements 100-150 may include one or more output components that may provide output information (e.g., a display, a liquid crystal display (LCD), light-emitting diodes (LEDs), organic light emitting diodes (OLEDs), a haptic feedback device, a speaker, and the like).

One or more of servers or terminals of elements 100-150 may further comprise a communication interface. The communication interface may include a receiver component, a transmitter component, and/or a transceiver component. The communication interface may enable one or more of servers or terminals of elements 100-150 to establish connections and/or transfer communications with other devices (e.g., a server, another device). The communications may be enabled via a wired connection, a wireless connection, or a combination of wired and wireless connections. The communication interface may permit one or more of servers or terminals of elements 100-150 to receive information from another device and/or provide information to another device. In some embodiments, the communication interface may provide communications with another device via a network, such as a local area network (LAN), a wide area network (WAN), a metropolitan area network (MAN), a private network, an ad hoc network, an intranet, the Internet, a fiber optic-based network, a cellular network (e.g., a fifth generation (5G) network, a long-term evolution (LTE) network, a third generation (3G) network, a code division multiple access (CDMA) network, and the like), a public land mobile network (PLMN), a telephone network (e.g., the Public Switched Telephone Network (PSTN)), or the like, and/or a combination of these or other types of networks. Alternatively or additionally, the communication interface may provide communications with another device via a device-to-device (D2D) communication link, such as FlashLinQ, WiMedia, Bluetooth, ZigBee, Wi-Fi, LTE, 5G, and the like. In other embodiments, the communication interface may include an Ethernet interface, an optical interface, a coaxial interface, an infrared interface, a radio frequency (RF) interface, or the like.

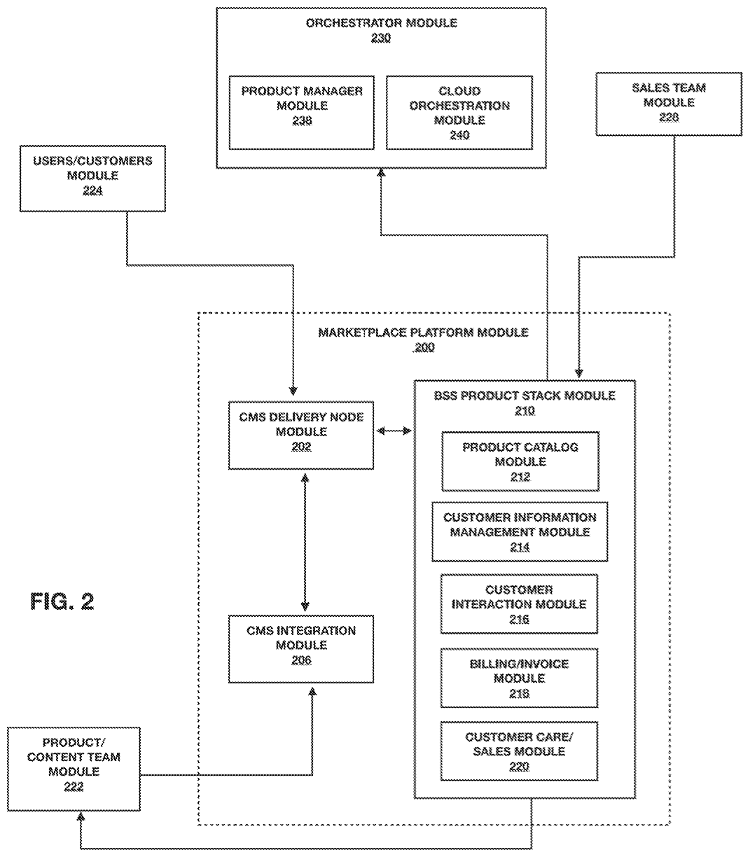

FIG. 2 illustrates an example system of a marketplace platform, according to one or more embodiments. Referring to FIG. 2, marketplace platform module or portal 200 can include a Customer Management System (CMS) delivery node module 202 which can be a portal for the marketplace platform and is in bidirectional communication with a Business Support System (BSS) product stack module or portal 210 (including any one or more of modules 212-220 illustrated in FIG. 2), and a CMS integration module or portal 206 for content management and integrating with various repositories.

Users/customers module or portal 224 (e.g., a user terminal or client device) can access the marketplace via communication with CMS delivery node module or portal 202. In some embodiments, users/customers module or portal 224 can also be in communication with a Content Distribution Network (CDN) module or portal which is further in communication with modules or portals 202 and 206. In some embodiments, the CMS delivery node module or portal 202 can address a first customer interaction when the customer accesses the marketplace platform 200 according to one or more embodiments. For example, the CMS delivery node module or portal 202 can receive a request from a user terminal or portal 224 to view the available products/services, retrieve product/service data from a product catalog, and generate/present a graphical user interface (GUI) representation (e.g., column, list, etc.) illustrating available products/services of the marketplace platform or of one or more service providers or vendors.

In addition, a product/content team module or portal 222 (e.g., a terminal or client devices of a seller, service provider, vendor, etc.) may also be in communication with the marketplace platform module or portal via communication with the CMS integration module or portal 206. In this case, the CMS integration module or portal 206 can generate and/or present GUI relevant to a seller, service provider, vendor, etc. (e.g., user interfaces for listing products for sale, configuring sales listings, generating or editing customer or product configuration profiles, promoting sales activity, etc.).

Still referring to FIG. 2, the marketplace platform module or portal 200 according to one or more embodiments may also include the BSS product stack module or portal 210. Here, module 210 may further include a product catalog module or portal 212 which can be a repository/data storage for storing product/service data. Further, module 212 may also include and store product/service level promotional offers or price reduction indicators or events associated with one or more stored products/services. Module 210 may also include a customer information management (CIM) module or portal 214 which can be a repository/data storage for storing customer information (e.g., name, contact information, ID, customer interest list, customer level promotional offers or price reduction events, etc.). Module 210 may also include a customer interaction management module or portal 216 which can be a repository/data storage for storing information of the customer's interaction with the marketplace platform according to one or more embodiments (e.g., the interaction history of the customer with the interactive elements of the graphical user interface (GUI), communications between the customer and the service provider(s) or other customer(s), etc.)

Still referring to FIG. 2, module 210 can also include a billing/invoice module or portal 218 for storing information associated with the customer's billing/invoicing on a service provided in the marketplace platform (e.g., previously created invoice, billing history, etc.). In addition, module 210 may also include a customer care/sales module or portal 220 for storing information of the sales or customer-related activities (e.g., sales campaign history, promotion activities for a specific type of customer, historical sales analysis, etc.). In some embodiments, module 220 can identify data associated with sales activity and user's experiences, retrieve/collect the data from external data storages or from any of modules or portals 212-218, store such data in a repository included in module 220, and provide such data to the network service provider/vendor when required. For instance, module 220 may provide sales related information or data to a sales team module 228, such that the sales team which is utilizing the sales team module 228 may utilize said information or data when required. Alternatively, module 220 can also be in communication with the product/content team module or portal 222. Here, the product/content team module or portal 222 can be users or a portal for users (e.g., vendors/service providers) who want to promote/sell network services. In addition, product/content team module or portal 222 can be a lead converter system or users who want to convert customer leads, analyze customer activity, and promote pre-sales and post-sales activities and marketing campaigns.

Still referring to FIG. 2, the marketplace platform module or portal 200 may also be in communication with an orchestrator module 230 (e.g., via an Application Programming Interface (API)). In particular, any one or more of modules or portals 212-220 of module 210 may be in communication with and/or supported by any of modules or portals 238-240 of module 230. Specifically, orchestrator module 230 can include a product/service management module 238 and a cloud orchestration module 240. In particular, any of modules 238-240 can be containerized and stored in a “cloud” or within cloud clusters on external servers and databases. In some embodiments, product/service management module 238 comprises a repository/data storage for storing products and services provided by a vendor/service provider. In some embodiments, the products and services are virtualized or are software-based. In some embodiments, the cloud orchestration module 240 is configured to schedule and provide the products and services to a user of the network services marketplace platform.

The modules illustrated in FIG. 2 are associated to the features for trading (e.g., selling, buying, promoting, etc.) a product or service in the marketplace platform. In addition to said modules in FIG. 2, the marketplace platform may also comprises modules for managing information associated with a product or service (e.g., information of a provider of the product or service, etc.).

### Information Management Systems and Modules

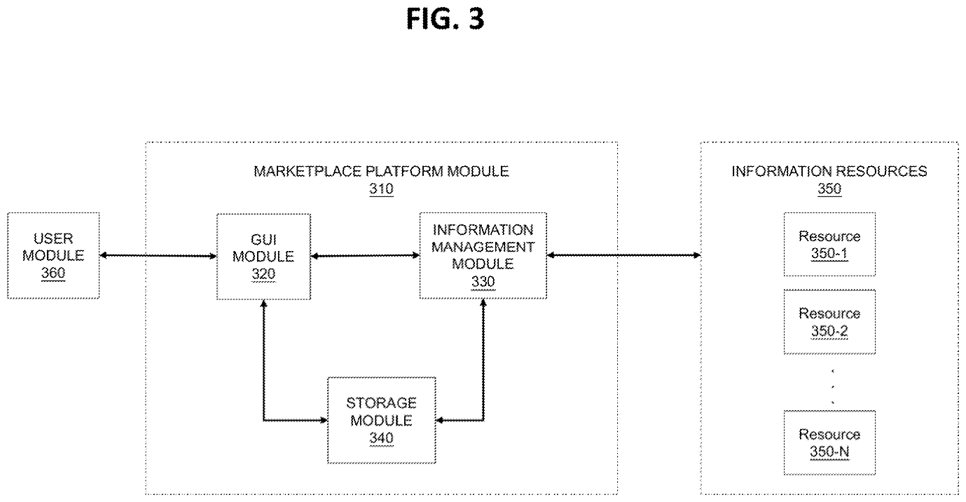

FIG. 3 illustrates an example block diagram of system modules for managing information associated with a service (or a product), according to one or more embodiments. The marketplace platform module 310 in FIG. 3 may correspond to marketplace platform module 200 in FIG. 2, and may include one or more modules illustrated in FIG. 2, thus the associated operations and features described above are similarly applicable herein unless being explicitly described otherwise.

Referring to FIG. 3, the marketplace platform module 310 may include a Graphical User Interface (GUI) module 320, an information management module 330, and a storage module 340. Further, the marketplace platform module 310 (or one or more modules included therein) may be communicatively coupled to one or more information resources 350 and to a user module 360.

To this end, the GUI module 320 may correspond to any module which is capable of generating and presenting one or more GUIs (e.g., CMS delivery node module 202 or CMS integration module 206 in FIG. 2, etc.), and the user module 360 may correspond to any module which is capable of communicating with a user (e.g., module 222, module 224, or module 228 in FIG. 2, etc.). Thus, the associated operations and features described above are similarly applicable herein unless specifically described otherwise, and the redundant descriptions associated therewith may be omitted below for conciseness.

Referring still to FIG. 3, the GUI module 320 may be communicatively coupled to the user module 360, the information management module 330, and the storage module 340. According to embodiments, the GUI module 320 may be configured to obtain information or data from the information management module 330 and/or from the storage module 340, and to generate one or more GUIs based on the obtained information or data. Subsequently, the GUI module 320 may be configured to present the one or more GUIs to a user of the marketplace platform via the user module 360.

The one or more GUIs may include information of a service associated with the user (e.g., service selected by the user, service subscribed by the user, service recommended by the marketplace to the user, etc.), such as (but are not limited to) information associated with a provider of the service, pricing of the service, appearance or design of the service, key feature(s) of the service, and any other suitable information.

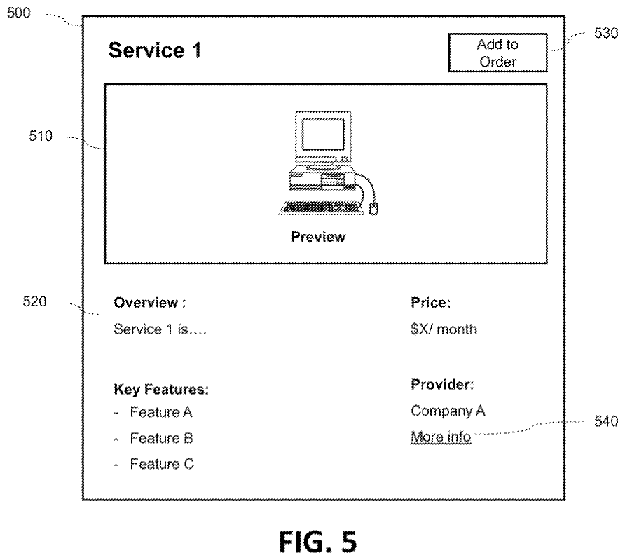

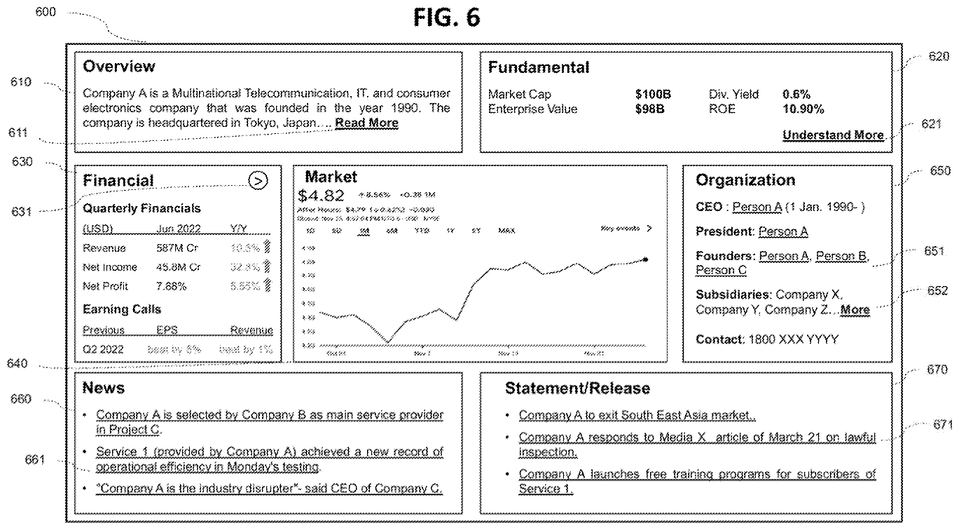

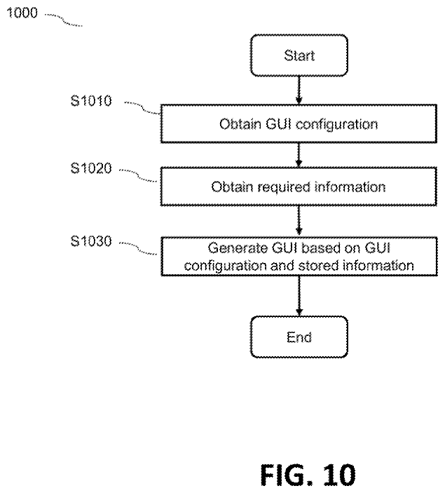

Further, the one or more GUIs may include one or more interactive elements (e.g., button, slider, drop-down list, clickable link, movable block, interactable text, etc.) which, when being interacted by the user, perform an associated operation to manage the information included in the one or more GUIs. Further descriptions associated with the one or more GUIs are provided below with reference to FIG. 5 and FIG. 6, and further descriptions associated with the operations of GUI module 330 are provided below with reference to FIG. 10.

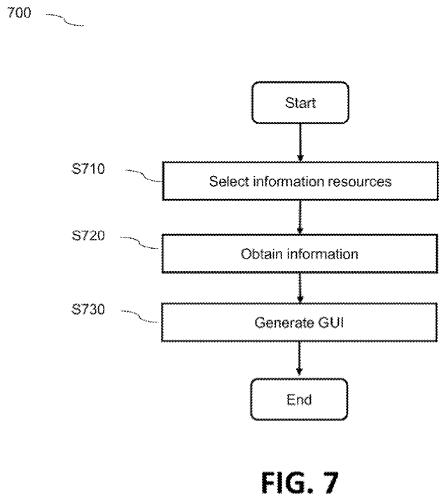

The information management module 330 may be communicatively coupled to the GUI module 320, the storage module 340, and the information resources 350. According to embodiments, the information management module 330 may be configured to receive data or information from the GUI module 320, to obtain information from the information resources 350, to process the obtained information, to provide the processed information to the GUI module 320, and to store the obtained information and/or processed information to the storage module 340. Further descriptions associated with the operations of information management module 330 are provided below with reference to FIG. 7 to FIG. 9.

The storage module 340 may be communicatively coupled to the GUI module 320 and the information management module 330. According to embodiments, the storage module 340 may be configured to store information or data provided by the GUI module 320 and the information management module 330, as well as to provide information or data to the GUI module 320 and the information management module 330. For instance, the GUI module 320 may be configured to store a list of information resources and to provide said list to information management module 330, such that information management module 330 may determine which information resource(s) should be accessed based thereon. Further, the storage module 340 may also store the information or data obtained by the information management module 330 (e.g., in raw data format, in processed data format, etc.) and to provide the same to the GUI module 320 when required. Furthermore, the storage module 340 may also be configured to store configuration information (e.g., a configuration profile, etc.) defining one or more formats (e.g., pre-set by the marketplace admin, customized by the user, etc.) for presenting the obtained information and to provide the same to the GUI module 320 when required.

On the other hand, the information resources 350 may include a plurality of resources (350-1 to 350-N) which host or contain one or more types of information, each of the plurality of resources may be communicatively coupled (e.g., via a network, etc.) to the information management module 330. According to embodiments, one or more of the information resources may include any publicly available information resources, such as (but are not limited to): official website (e.g., company website, government website, etc.), open source platform, digital encyclopedia (e.g., online encyclopedia, offline encyclopedia, etc.), media platform (e.g., verified social platform pages, etc.), software application (e.g., newsletter, market tracking, etc.), and any other suitable element or device for providing publicly available information.

The information or data provided by the information resources 350 to the information management module 330 may include information of any suitable category, such as (but are not limited to):
(1) Overview information of a provider associated with a service deployed in the marketplace platform. This information may encompass information which allow the user to quickly grasp the nature and background of the provider. For instance, said information may include: descriptions of historical background (e.g., founded year, previous achievement, etc.), the associated field (e.g., technical field, business field, etc.), specialization, major investors, and the like. In some embodiments, this information may be presented in a paragraph form introducing the provider, with or without an icon (e.g., company logo, etc.) associated with the provider.
(2) Fundamental information of a company associated with the provider. This information may encompass information which allow the user to assess the reliability and/or the growth potential of the provider. For instance, said information may include one or more of the following parameters: market cap, enterprise value, division yield, return on equity (ROE), revenue, operating income, net income, total assets, total equity, number of employees, type (public, private, etc.), industry, predecessors, founded years, founder(s), headquarter(s), area served (e.g., worldwide, etc.), key people, product(s), division(s), subsidiaries, website, and the like.
(3) Financial information associated with the provider. This information may encompass information which allow the user to understand the financial status and financial potential/capability of the provider. For instance, said information may define financials of the provider's company shares and dividends to provide insights into the company's financial performance and prospects. The information may include one or more of the following parameters: revenue, net income, net profit, gross profit, dividends (e.g., dividend per share, dividend yield, etc.), market capitalization, quarterly growth, analyst target price, earnings before interest taxes depreciation and amortization (EBITDA), price-to-earnings (PE) ratio, PE to growth ratio (PEG Ratio), trailing PE, forward PE, price to sales ratio, price to book ratio, book value, enterprise value (EV) to revenue, EV to EBITDA, earnings per share (EPS), dilute EPS, revenue per share, profit margin, operating margin, return on assets, return on equity, volatility of returns (e.g., Beta, etc.), quarterly earnings growth (e.g., year over year (YOY), etc.), quarterly revenue growth (e.g., YOY, etc.), analyst target price, week(s) high, week(s) low, day(s) moving average, share outstanding, dividend date, reinvestment date (e.g., ex-dividend date, etc.), and the like. Further, the financial information may also include credit score ranges, credit history, and any other suitable information for determining the credit level and financial reliability of the provider.
(4) Market information associated with the provider. This information may encompass information which allows the user to understand the performance of the provider's company share(s) in the market. Said information may include further details of the financial information described above, such as: current stock price, historical stock price, buying and selling volume, and the like.
(5) News and event information associated with the provider. This information may encompass information which allows the user to understand the news, third party opinions, upcoming events, and the like, of the provider. For instance, said information may include digital news, comments or posts from official/verified accounts on a social platform, online articles, and the like.
(6) Official statement or release information. This information may encompass information which allows the user to understand the official statement and information provided by the provider. Said information may include recent activities (e.g., acquisitions, achievements, etc.), statement to stakeholders (e.g., bonus, dividends, etc.), official announcements, upcoming product release, and the like.

It can be understood that any other suitable information may be provided by information resources 350, and the scope of the present disclosure should not be limited to the examples information or categories described above. Further, it is contemplated that one or more of the above described information may be combined (by the marketplace platform module 310 or one or more modules included therein) or be overlapped with other information (e.g., one or more financial information may also be included in fundamental information, etc.), without departing from the scope of the present disclosure.

Further, it can be understood that the arrangement or configuration of the system in FIG. 3 are merely an example provided for descriptive purpose, and the system may be arranged or be configured in a different manner as illustrated in FIG. 3. For instance, more than one storage module 340 may be included in the system, the storage module 340 may be located external from the marketplace platform module 310, the GUI module 320 and the information management module 330 may be a combined module which perform the operations of both modules 320 and 330, and the like. Furthermore, it can also be understood that one or more of the modules 320 and 330 may be implemented in the form of computer-readable or computer-executable instructions which, when being executed by at least one processor, perform one or more operations of said modules 320 and 330.

To this end, a user may access the marketplace platform module 310 (via user module 360) to view for available service(s) or product(s), and to plan the purchase or subscription of the service(s) or product(s) therefrom. The marketplace platform module (or one or more modules included therein) may generate and present the information of the available service(s) or product(s) to the user in the form of GUI.

The user may want to view the information of the provider of the service(s) or product(s) before making a purchase or subscription decision. In that case, the user may interact with the presented GUI, and the marketplace platform module may automatically and dynamically manage (e.g., determine most optimal information resources, collect required information, process the collected information, update the information, etc.) and present the information to the user. Accordingly, the example embodiments of the present disclosure simplify the product/service review and decision making processes since the system automatically obtain the most optimal (e.g., most updated, most trustable, etc.) information from multiple resources and present the information to the user in real-time or near real-time, without requiring the user to manually search and collect the information.

Further descriptions of the apparatus, system, and method provided by the example embodiments of the present disclosures are provided hereinbelow.

### General Operations of Information Management

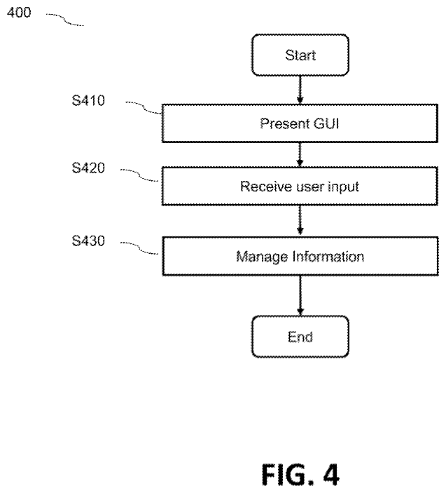

FIG. 4 illustrates an example flow diagram of a method 400 for managing information, according to one or more embodiments. One or more operations of the method 400 may be performed by the marketplace platform module 310 in FIG. 3 (or one or more modules included therein). According to embodiments, method 400 may be performed after a user has selected a service from a plurality of available services to view the detail of the service.

Referring to FIG. 4, at operation S401, a graphical user interface (GUI) is presented to a user. For instance, the GUI module (e.g., module 320 in FIG. 3) may generate a first GUI containing information of a service (e.g., a service selected by the user from a plurality of available services, etc.) and present the first GUI to the user via a user module (e.g., user module 360 in FIG. 3). According to an embodiment, upon detecting a selection of the service, the GUI module may obtain, from a storage module (e.g., storage module 340 in FIG. 3), information or data associated with the selected service, generate the first GUI based on the obtained information or data, and present the first GUI to the user.

FIG. 5 illustrates an example of the first GUI, according to one and more embodiments. Referring to FIG. 5, a GUI 500 containing information of a service (illustrated as “Service 1” in FIG. 5) and a plurality of interactive elements may be presented to the user. According to embodiments, the GUI 500 may be presented to the user upon detecting that the user has selected the service to view further detail thereof.

As illustrated in FIG. 5, GUI 500 may include a preview window 510 containing image(s) associated with the service (e.g., system diagram, service design, testing result/proof, campaign advertisement, etc.), one or more information describing the service (e.g., overview, key features, price, provider, etc.), a first interactive element 530 which, when being interacted by the user, perform one or more associated operations (e.g., ordering, purchasing, subscribing, payment information inputting, etc.), and a second interactive element 540 which, when being interacted by the user, perform one or more operations for managing (e.g., determining, collecting, processing, updating, presenting, customizing, etc.) information associated with the provider.

From the first GUI, the user may review the information of the selected service, and may opt to place the order of the selected service by interacting (e.g., pressing, clicking, etc.) with the first interactive element 530. In some situations, the user may want to review further details of the selected service (e.g., the user would like to know more about the provider of the service (illustrated as “Company A” in FIG. 5), etc.) before making the order or purchasing decision. In that case, the user may interact with the second interactive element 540 to view the further details of the selected service.

It can be understood that, although it is illustrated in FIG. 5 that the second interactive element 540 is presented in the form of interactable texts (e.g., hypertext, etc.), the second interactive element 540 may also be presented in any other suitable form (e.g., a interactable button, an interactable icon, etc.), without departing from the scope of the present disclosure.

Referring back to FIG. 4, at operation S420, one or more user inputs are received. For instance, the GUI module may be configured to receive one or more user interactions with one or more interactive elements (e.g., interactive elements 530 and/or 540 in FIG. 5, etc.) included in the first GUI. In that case, the one or more user inputs may include a user input for obtaining further information of the service (e.g., further information of the provider of the service, etc.), a user input for adding the service to a purchase list, a user input for purchasing/subscribing to the service, and the like.

Subsequently, at operation S430, information associated with the service is managed based on the received user input(s). For instance, the GUI module 320 may determine a type of user input and may perform an appropriate operation(s) to manage the required information thereafter.

In an example embodiment which the user has interacted with the interactive element for ordering or purchasing the service, the GUI module may be configured to generate one or more additional GUIs containing required information and interactive element(s) to allow the user to place the order or make the purchase.

In another example embodiment which the user has interacted with the interactive element for obtaining or viewing further information of the service (e.g., further information of the provider, etc.), the GUI module may interoperate with an information management module (e.g., information management module 330 in FIG. 3) to generate a second GUI (may also be referred to as “information GUI” hereinafter) containing further information of the service and present the second GUI to the user. Further descriptions associated with the operations of generating the second GUI is provided below with reference to FIG. 7 to FIG. 10.

Referring next to FIG. 6, which illustrates an example of the second GUI, according to one and more embodiments. GUI 600 of FIG. 6 may be generated by the GUI module upon detecting a user interaction with an associated interactive element (e.g., element 540 in FIG. 5, etc.) and may be presented to the user in real-time or near real-time.

According to embodiments, GUI 600 may be presented in the form of a pop-up window overlaying the first GUI (e.g., GUI 500 of FIG. 5). Further, it is contemplated that the GUI module may be configured to receive one or more user interactions on one or more interactive elements included in GUI 600 and to perform an associated operation thereafter.

Referring to FIG. 6, the GUI 600 may include a plurality of block elements 610-670, each of which may contain information of a specific category and may contain one or more interactive elements. Specifically, in the example embodiment of FIG. 6, block element 610 may contain information of “overview” category and an interactive element 611, block element 620 may contain information of “fundamental” category and an interactive element 621, block element 630 may contain information of “financial” category and an interactive element 631, block element 640 may contain information of “market” category and may contain an interactive statistic element (e.g., graph, chart, etc.), block element 650 may contain information of “organization” category and may contain interactive elements 651-652, block element 660 may contain information of “news” category and may contain a plurality of interactive texts 661, and block element 670 may contain information of “statement/release” category and may contain a plurality of interactive texts 671.

It is contemplated that the GUI 600 may also include more or less block element(s) than as illustrated in FIG. 6, and/or the arrangement of block elements 610-670 may be different from as illustrated in FIG. 6 (e.g., all block elements may include interactive elements 631, the block element 640 may be presented at the top right corner of GUI 600, etc.).

One or more information included in one or more of the block elements 610-670 may be obtained from a plurality of information resources. For instance, information in block element 610 and information in block element 620 may be obtained from different information resources, a portion of information in block element 660 may be obtained from an information resource different from another portion of information in the same block element 660, and the like.

Further, one or more of the block elements 610-670 may be interactable by the user. According to embodiments, one or more of the block elements 610-670, when being interacted (e.g., clicked, tapped, triggered via voice control, etc.) by the user, may direct the user to the original information resource(s) from which the information included therein is obtained. For instance, based on determining or receiving a user interaction with block element 640, the GUI module may direct the user (e.g., by generating and presenting one or more additional GUIs, by sending an associated uniform resource locator (URL) link to the user module and instructing the user module to access the URL link, etc.) to the information resource (e.g., webpage, application, etc.) from which the market information is obtained, and the like. Similarly, the interactive element(s) included in the block elements may perform the similar function as described above. For instance, based on determining or receiving a user interaction with interactive element 631 in block element 630, the GUI module may direct the user to the information resource(s) from which the financial information are retracted.

According to other embodiments, one or more of the block elements 610-670 (or one or more interactive elements included therein), when being interacted by the user, may provide further information and/or function to the user. For instance, based on determining or receiving a user interaction with block element 630, the GUI module may generate an updated block element 630 with an enlarged view (e.g., overlaying one or more of other block elements, etc.) that contains additional financial information, and the like. As another example, the market information (e.g., stock price, etc.) in block element 640 may be presented in a financial chart (e.g., candlestick chart, etc.) which, when being interacted by the user, allow the user to view detail information or change the presented information. For instance, the user may select or tip on a time point in the financial chart and the financial detail such as open price, close price, low price, high price, and the like at that time point may be presented in a sub-window overlaying the financial chart, or the user may select to view the market information in different time period (e.g., market information per year, per quarter, per month, per day, etc.) and the GUI module may update the financial chart to present the market information according to the user-selected time period.

According to yet other embodiments, presentation of one or more of the block elements 610-670 (or one or more interactive elements included therein) may be re-arranged according to one or more user interactions. For instance, the user may arrange the location of one or more of the block elements 610-670 by dragging and dropping the block element(s) to a desired location(s), may arrange the size of one or more of the block elements 610-670 by clicking on the block element(s) and adjusting the size of the selected block element(s) (e.g., scrolling a scroll wheel on a mouse, etc.) until the selected block element(s) arrive at the desired size, and the like.

Further, one or more information and/or one or more interactive elements in one or more of the block elements 610-670 may be presented in a distinguished manner from other information. For example, as illustrated in FIG. 6, the interactive texts (e.g., elements 611, 621, 651, 652, 661, and 671) are underlined so as to distinguish from non-interactive texts. Further, key information or important information (e.g., values of fundamental information in block element 620, raise/drop of financial performance, etc.) may be presented in bold-form and/or in specific colors (e.g., red, green, etc.), so as to distinguish from other information.

Furthermore, it can be understood that GUI 600 may include any other suitable interactive elements, in addition to those illustrated in FIG. 6.

According to embodiments, GUI 600 may include one or more interactive elements (e.g., a refresh button, etc.) which, when being interacted by the user, trigger the marketplace platform module (or one or more modules included therein) to determine optimal information resources, to obtain the latest or the most recent information from the determined information resources, and to update GUI 600 to include the most updated information. Alternatively, GUI 600 may include one or more interactive elements (e.g., a slider, a drop-down list, etc.) which allow the user to specify the time interval to automatically refresh or update the GUI 600, and the marketplace platform (or one or more modules included therein) may be configured to update GUI 600 according to the user-specified time interval.

According to other embodiments, GUI 600 may include one or more interactive elements which, when being interacted by the user, allow the user to specify the information presented in the GUI. For instance, GUI 600 may include a search box which may receive one or more keywords from the user, and the marketplace platform module (or one or more modules included therein) may be configured to obtain the information more specific or more closely related to the user-inputted keywords and to update one or more block elements of GUI 600 to present said information. Further, GUI 600 may include a plurality of check-boxes, a drop-down list containing a plurality of selectable options, and any other suitable interactive elements, which allow the user to select or specify the information of his/her interest, such that the marketplace platform module (or one or more modules included therein) may obtain, generate, and present said information to the user in GUI 600.

According to yet other embodiments, GUI 600 (or one or more elements included therein) may include one or more interactive elements (e.g., exit button, etc.) which, when being interacted by the user, redirect the user to the previous GUI. For instance, based on determining or receiving a user interaction with an exit button to exit GUI 600, the GUI module may be configured to close the GUI 600 and present GUI 500 (in FIG. 5) to the user.

According to yet other embodiments, GUI 600 may include information defining sentimental category of one or more of the information presented in the GUI 600. For instance, one or more of the news information may be presented with an associated sentimental category (e.g., bullish, bearish, somewhat-bullish, somewhat-bearish, biased, neutral, etc.) in block element 660. The sentimental category may be determined by the marketplace platform module (e.g., information management module 330) and may be presented in any suitable forms, such as: values (e.g., value of “10” indicates bullish, value of “7” indicates somewhat “bullish”, etc.), grades (e.g., grade “A” indicates bullish, grade “D” indicates “bearish”, etc.), and the like. In this way, the nature of the presented information may be presented to the user in a summarized or categorized manner, which allow the user to quickly grasp the main point of the presented information.

### Generation of Information GUI

The operations of managing the information (e.g., determining information resource(s), obtaining information resource(s), etc.) and generating an information GUI (e.g., GUI containing information or portfolio of the provider such as GUI 600 in FIG. 6, etc.) will be described herein.

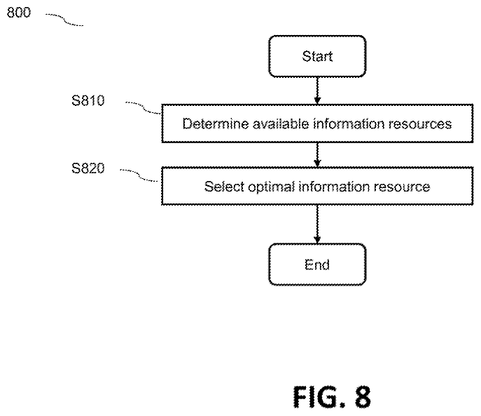

FIG. 7 illustrates an example flow diagram of a method 700 for generating the information GUI, according to one or more embodiments. Further descriptions of one or more of operations of method 700 according to one or more embodiments are described below with reference to FIG. 8 to FIG. 10. One or more operations in FIG. 7 to FIG. 10 may be performed by a marketplace platform module (or one or more modules included therein) in response to a trigger or an event (e.g., a user interaction with an interactive element such as an interactive text element 540 in FIG. 5), a refresh/update button included in a presented information GUI (GUI 600 in FIG. 6), etc.), or may be performed by the marketplace platform module continuously or periodically (e.g., based on a time period predefined by the system admin, based on a time interval specified by the user, etc.).

Referring to FIG. 7, at operation S710, one or more information resources are selected. Specifically, upon determining that generation or update of the information GUI is required (e.g., a user has interacted with an associated interactive element, a time period is arrived or is within a predetermined threshold, etc.), an information management module (e.g., information management module 330 in FIG. 3, etc.) may be configured to select appropriate information resources from which the information to be included in the information GUI is obtained. Further descriptions associated with the operation S710 are provided below with reference to FIG. 8.

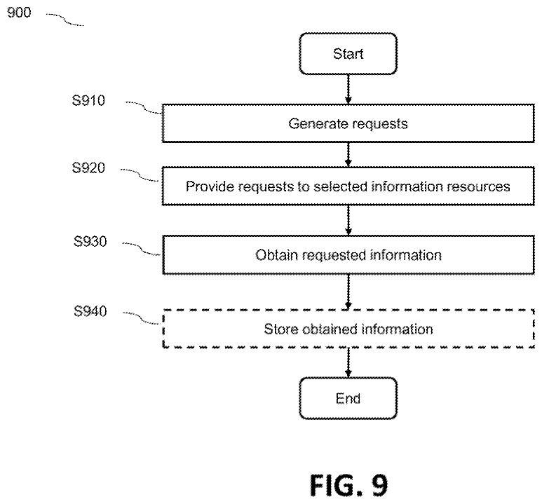

At operation S720, one or more information are obtained. Specifically, the information management module may be configured to access the selected one or more information resources to obtain one or more information therefrom. In addition, after obtaining the information and/or the associated data, the information management module may be configured to store the information and/or data in a storage module (e.g., storage module 340 in FIG. 3, etc.). Further descriptions associated with the operation S720 are provided below with reference to FIG. 9

At operation S730, the information GUI is generated. Specifically, a GUI module (e.g., GUI module 320 in FIG. 3, etc.) may be configured to obtain the information (e.g., obtain directly from the information management module, obtain from the storage module, etc.) and to generate the information GUI based thereon. Further descriptions associated with the operation S730 are provided below with reference to FIG. 10.

Next, additional embodiments associated with operations S710 to S730 will be described hereinbelow with reference to FIG. 8 to FIG. 10.

Referring first to FIG. 8, which illustrates an example flow diagram of a method 800 for selecting one or more information resources, according to one or more embodiments. Method 800 may be part of operation S710 in FIG. 7, and may be performed by the information management module 330 in FIG. 3.

At operation S810, one or more available information resources are determined. Specifically, the information management module may be configured to obtain (e.g., from the storage module, etc.) information associated with a plurality of information resources predetermined as trusted/reliable information resources (e.g., information resources verified by the system admin or marketplace platform operator, officially authenticated information resources, information resources included by or requested by the user, etc.), and to determine the one or more available information resources therefrom. Information of the plurality of predetermined information resources (e.g., domain name, type of the information resources and/or the type of content included therein (e.g., hypertext transfer protocol secure (HTTPS) based, Python programming based, etc.), URL address, etc.) may be stored in the storage module 340 in the form of a list (or any other suitable recording format).

To this end, the information management module may be configured to verify which of the plurality of predetermined information resources are available (e.g., available to be accessed, etc.) by, for example, performing a ping test (or any other suitable operations) with each of the plurality of predetermined information resources, and determining the one or more available information resources therefrom.

Subsequently, at operation S820, one or more optimal information resources are selected. Specifically, the information management module may be configured to select the one or more optimal information resources from the one or more available information resources. According to embodiments, the information management module may be configured to perform one or more analysis operations on one or more contents hosted on the one or more available information resources, to determine which of the one or more available information resources contain the latest possible information (e.g., by comparing a current time with a timestamp or any suitable information defining the last updated time of the one or more contents, etc.), and to select the information resource(s) which contain the latest possible information as the one or more optimal information resources. Upon selecting the one or more optimal information resources, the information management module may perform operation S720 to obtain information and/or data from the selected one or more optimal information resources.

Referring next to FIG. 9, which illustrates a flow diagram of a method 900 for obtaining one or more information, according to one or more embodiments. Method 900 may be part of operation S720 in FIG. 7, and may be performed by the information management module 330 in FIG. 3. Further, method 900 may be performed to obtain one or more information from one or more optimal information resources selected via method 800 in FIG. 8.

According to embodiments, one or more operations of method 900 may include a content scraping operation(s), in which a portion of content hosted on the one or more information resources are downloaded and the desired information are extracted therefrom.

Referring to FIG. 9, at operation S910, one or more requests are generated. Specifically, the information management module may be configured to generate one or more requests to obtain the required information from the one or more information resources (e.g., one or more selected optimal information resources, etc.).

According to embodiments, the information management module may be configured to generate the one or more requests based on the type of the information resource(s) and/or the content included therein. For instance, based on determining that an information resource is HTTPS based, the information management module 330 may be configured to generate one or more HTTPS requests including the details of the desired information. As another example, based on determining that an information (e.g., a graph, a chart, etc.) included in the information resource is Python based, the information management module 330 may be configured to generate one or more requests by utilizing an associated Python packages or libraries (e.g., Urllib, Beautiful Soup, Scrapy, etc.).

At operation S920, the one or more requests are provided to the respective information resource(s). Specifically, the information management module may be configured to send the one or more requests to the respective optimal information resource(s). According to embodiments in which multiple requests are generated (e.g., multiple optimal information resources are selected, multiple types of information are included in one optimal information resources, etc.), the information management module may be configured to provide the multiple requests concurrently, sequentially, or a combination thereof.

At operation S930, one or more of the requested information are obtained. Specifically, the information management module may be configured to receive one or more responses from the one or more information resources, to which the one or more requests were sent. The one or more responses may include the requested information.

According to embodiments, the one or more responses (or the information included therein) may be in one or more formats, such as (but are not limited to): a comma-separated values (CSV) format, a hypertext markup language (HTML) format, and a JSON format.

According to embodiments, the one or more responses may include only the requested information. In that case, the information management module may simply store the received information into the storage module (at optional operation S940), without preprocessing the received information. According to other embodiments, the one or more responses may include the requested information and one or more non-related information (e.g., a graph is requested from a webpage and the graph is provided along with advertisement information posted on the webpage, etc.). In that case, the information management module may be configured to process (e.g., extract, filter, etc.) the received information to retain the requested information and to discard the non-related information (e.g., to retain only the graph and to discard the advertisement information, etc.). Subsequently, the information management module may store the processed information in the storage module (at optional operation S940). To this end, the information (or raw data associated therewith) obtained from the information resource(s) may be stored in the storage module for future use, while the non-related information may be removed.

According to embodiments, the information management module may be configured to further process one or more of the obtained information (or the data associated therewith).

For instance, the information management module may convert an obtained information (or the data associated therewith) from a first format (e.g., HTML, etc.) to a second format (e.g., JSON, etc.), such that the format(s) of the information can be standardized, normalized, and/or complied to the system requirement and/or user requirement.

Further, the information management module may perform information or data enrichment operation on the obtained information. For instance, the information management module may perform text checking to correct any spelling error or grammatical error, may adjust the color of an image to improve visibility, may organize a content to improve readability, and the like. According to embodiments, the information management module may be configured to perform sentiment analysis (e.g., via keyword based operations, via utilizing one or more artificial intelligence (AI) models, etc.) to determine a sentiment nature of the obtained information, and to assign or map a sentiment category (bullish, bearish, somewhat-bullish, somewhat-bearish, biased, neutral, etc.) to the obtained information. Further, the information may be configured to assign to or include in the obtained information, the information for accessing the associated information resource (e.g., URL link, etc.).

The above described example processing operations may be performed by the information management module upon obtaining the information or data, and the processed information or data may be stored by the information management module in the storage module (at operation S940). Alternatively, said operations may be performed by information management module at a later time, for example, in response to a request from the GUI module during the generation of the information GUI and the processed information or data may be provided by the information management module to the GUI module in real-time or near real-time.

Referring now to FIG. 10, which illustrates an example flow diagram of a method 1000 for generating the information GUI, according to one or more embodiments. Method 1000 may be part of operation S730 in FIG. 7, and may be performed by the GUI module 320 in FIG. 3. Further, method 1000 may be performed based on the information and/or data obtained via method 900 in FIG. 9.

Referring to FIG. 10, at operation S1010, configuration associated with the information GUI is obtained. Specifically, the GUI module may be configured to obtain a configuration profile including information defining the configuration of the information GUI, such as configuration of the block element(s) to be presented in the information GUI (e.g., number of block elements to be presented, size of each block elements, how much details or content should be presented in each block element, arrangement or location of each of the block elements, interactive element(s) to be included in each block element, etc.), configuration of the interactive element(s) to be included in the information GUI, and any other suitable configurations (e.g., time period to automatically update the information GUI, etc.).

Accordingly, at operation S1020, one or more required information are obtained. Specifically, the GUI module may be configured to determine (based on the configuration information of the information GUI) which information are required for generating the information GUI, to determine which information (e.g., information stored in the storage module, information provided by information management module on the fly, etc.) are suitable to be presented in the information GUI, and the like, and to obtain the required information from the storage module and/or from the information management module thereafter.

For example, during generating the information GUI 600 in FIG. 6, the GUI module may determine (from the configuration information) that the information GUI should present information associated with the categories of “overview”, “fundamental”, “financial”, “market”, “organization”, “news”, and “statement/release”. Accordingly, GUI module may access the storage module and/or the information management module to search for information which are associated with said categories. Next, the GUI module may, for example, determine which of the information associated with said categories is the most recent information (e.g., by comparing a current time to the timestamp of the information, etc.), and may obtain said most recent information thereafter.

At operation S1030, the information GUI may be generated. Specifically, the GUI module may be configured to generate the information GUI based on the configuration information (obtained at operation S1010) and the required information (obtained at operation S1020). For example, during generating the information GUI 600 in FIG. 6, the GUI module may determine from the configuration information that block element associated with “overview” category should be located at the top left corner of GUI 600, block element associated with “fundamental” category should be located at the top right corner of GUI 600, and the like, and may thus generate said block elements on the respective locations.

Similar approach or operation is also applicable in determining which information or interactive element(s) should be included in the GUI 600 and the block elements. For example, the GUI module may determine (from the configuration information) that the block element associated with “fundamental” category should present information associated with “market cap”, “enterprise value”, “dividend yield”, and “return on equity”, and may thus insert said information into said block element and include an interactive element (e.g., a button, a hypertext, etc.) which may direct the user to the information resource when being interacted and/or may generate one or more additional GUIs or update the GUI 600 to present further information of associated with “fundamental” category.

To this end, example embodiments of the present disclosure may effectively and efficiently manage and present information to the user.

Example embodiments of the present disclosure may improve the accuracy of the user's decision, since the information presented to the user are updated information and are obtained from reliable or trustworthy information resources, which in turns reduce the rate or possibility that the user making a decision based on non-accurate and/or non-reliable information.

Further, example embodiments of the present disclosure may enable the user to easily obtain the required information. For instance, the user may obtain the required information via a simple interaction with the associated interactive element (e.g., a single click on a button, etc.), and the system may automatically collect, process, and present the required information in a GUI(s). Furthermore, the GUI(s) in the example embodiments of the present disclosure is generated dynamically (e.g., the optimal information resource(s) is determined on-the-fly, the latest information are obtained in real-time or near real-time, etc.), and the information presented in the GUI(s) may be efficiently updated (e.g., updated in response to a user interaction with an interactive element in the GUI(s), updated automatically by the system in a predetermined time interval, etc.). Further still, the information in the GUI(s) are presented in a standardized and uniform manner, even if the information are obtained from different information resource(s).

In view of the above, not only the user experience may be significantly improved and the user burden in manual searching for the information may be avoided or significantly reduced, the user may also quickly understand, plan, decide, and/or select which vendor(s) or service provider(s) is the best fit for their purpose or business plan. Ultimately, the decision making process from the user end may be simplified.

### Implementation Environment and Device

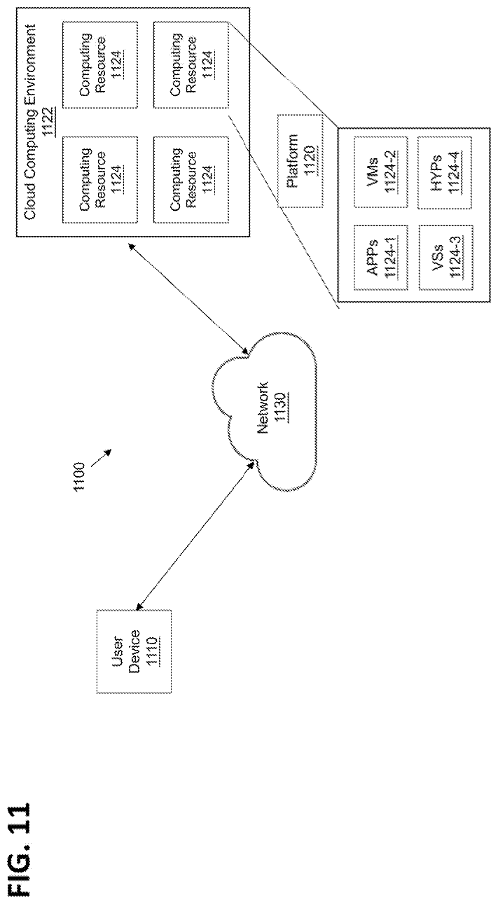

FIG. 11 is a diagram of an example environment 1100 in which systems and/or methods, described herein, may be implemented. As shown in FIG. 11, environment 1100 may include a user device 1110, a platform 1120, and a network 1130. Devices of environment 1100 may interconnect via wired connections, wireless connections, or a combination of wired and wireless connections. In embodiments, any of the functions and operations described with reference to FIG. 1 to FIG. 10 above may be performed by any combination of elements illustrated in FIG. 11.

User device 1110 includes one or more devices capable of receiving, generating, storing, processing, and/or providing information associated with platform 1120. For example, user device 1110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 1110 may receive information from and/or transmit information to platform 1120.

Platform 1120 includes one or more devices capable of receiving, generating, storing, processing, and/or providing information. In some implementations, platform 1120 may include a cloud server or a group of cloud servers. In some implementations, platform 1120 may be designed to be modular such that certain software components may be swapped in or out depending on a particular need. As such, platform 1120 may be easily and/or quickly reconfigured for different uses.

In some implementations, as shown, platform 1120 may be hosted in cloud computing environment 1122. Notably, while implementations described herein describe platform 1120 as being hosted in cloud computing environment 1122, in some implementations, platform 1120 may not be cloud-based (i.e., may be implemented outside of a cloud computing environment) or may be partially cloud-based.

Cloud computing environment 1122 includes an environment that hosts platform 1120. Cloud computing environment 1122 may provide computation, software, data access, storage, etc. services that do not require end-user (e.g., user device 1110) knowledge of a physical location and configuration of system(s) and/or device(s) that hosts platform 1120. As shown, cloud computing environment 1122 may include a group of computing resources 1124 (referred to collectively as “computing resources 1124” and individually as “computing resource 1124”).

Computing resource 1124 includes one or more personal computers, a cluster of computing devices, workstation computers, server devices, or other types of computation and/or communication devices. In some implementations, computing resource 1124 may host platform 1120. The cloud resources may include compute instances executing in computing resource 1124, storage devices provided in computing resource 1124, data transfer devices provided by computing resource 1124, etc. In some implementations, computing resource 1124 may communicate with other computing resources 1124 via wired connections, wireless connections, or a combination of wired and wireless connections.

As further shown in FIG. 11, computing resource 1124 includes a group of cloud resources, such as one or more applications (“APPs”) 1124-1, one or more virtual machines (“VMs”) 1124-2, virtualized storage (“VSs”) 1124-3, one or more hypervisors (“HYPs”) 1124-4, or the like.

Application 1124-1 includes one or more software applications that may be provided to or accessed by user device 1110. Application 1124-1 may eliminate a need to install and execute the software applications on user device 1110. For example, application 1124-1 may include software associated with platform 1120 and/or any other software capable of being provided via cloud computing environment 1122. In some implementations, one application 1124-1 may send/receive information to/from one or more other applications 1124-1, via virtual machine 1124-2.

Virtual machine 1124-2 includes a software implementation of a machine (e.g., a computer) that executes programs like a physical machine. Virtual machine 1124-2 may be either a system virtual machine or a process virtual machine, depending upon use and degree of correspondence to any real machine by virtual machine 1124-2. A system virtual machine may provide a complete system platform that supports execution of a complete operating system (“OS”). A process virtual machine may execute a single program, and may support a single process. In some implementations, virtual machine 1124-2 may execute on behalf of a user (e.g., user device 1110), and may manage infrastructure of cloud computing environment 1122, such as data management, synchronization, or long-duration data transfers.

Virtualized storage 1124-3 includes one or more storage systems and/or one or more devices that use virtualization techniques within the storage systems or devices of computing resource 1124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 1124-4 may provide hardware virtualization techniques that allow multiple operating systems (e.g., “guest operating systems”) to execute concurrently on a host computer, such as computing resource 1124. Hypervisor 1124-4 may present a virtual operating platform to the guest operating systems, and may manage the execution of the guest operating systems. Multiple instances of a variety of operating systems may share virtualized hardware resources.

Network 1130 includes one or more wired and/or wireless networks. For example, network 1130 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 11 are provided as an example. In practice, there may be additional devices and/or networks, fewer devices and/or networks, different devices and/or networks, or differently arranged devices and/or networks than those shown in FIG. 11. Furthermore, two or more devices shown in FIG. 11 may be implemented within a single device, or a single device shown in FIG. 11 may be implemented as multiple, distributed devices. Additionally, or alternatively, a set of devices (e.g., one or more devices) of environment 1100 may perform one or more functions described as being performed by another set of devices of environment 1100.

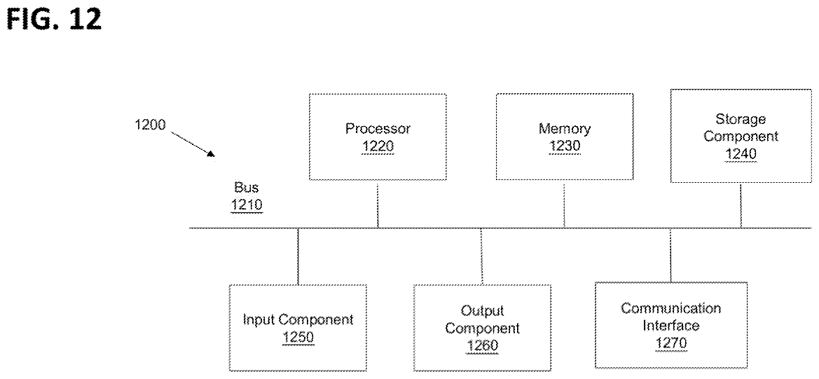

FIG. 12 is a diagram of example components of a device 1200. As shown in FIG. 12, device 1200 may include a bus 1210, a processor 1220, a memory 1230, a storage component 1240, an input component 1250, an output component 1260, and a communication interface 1270. In embodiments, any of the functions and operations described with reference to FIG. 1 to FIG. 11 above may be performed by any combination of elements illustrated in FIG. 12.

Bus 1210 includes a component that permits communication among the components of device 1200. Processor 1220 may be implemented in hardware, firmware, or a combination of hardware and software. Processor 1220 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 2190 includes one or more processors capable of being programmed to perform a function. Memory 1230 includes a random access memory (RAM), a read only memory (ROM), and/or another type of dynamic or static storage device (e.g., a flash memory, a magnetic memory, and/or an optical memory) that stores information and/or instructions for use by processor 1220.

Storage component 1240 stores information and/or software related to the operation and use of device 1200. For example, storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 1250 includes a component that permits device 1200 to receive information, such as via user input (e.g., a touch screen display, a keyboard, a keypad, a mouse, a button, a switch, and/or a microphone). Additionally, or alternatively, input component 1250 may include a sensor for sensing information (e.g., a global positioning system (GPS) component, an accelerometer, a gyroscope, and/or an actuator). Output component 1260 includes a component that provides output information from device 1200 (e.g., a display, a speaker, and/or one or more light-emitting diodes (LEDs)).

Communication interface 1270 includes a transceiver-like component (e.g., a transceiver and/or a separate receiver and transmitter) that enables device 1200 to communicate with other devices, such as via a wired connection, a wireless connection, or a combination of wired and wireless connections. Communication interface 1270 may permit device 1200 to receive information from another device and/or provide information to another device. For example, communication interface 1270 may include an Ethernet interface, an optical interface, a coaxial interface, an infrared interface, a radio frequency (RF) interface, a universal serial bus (USB) interface, a Wi-Fi interface, a cellular network interface, or the like.

Device 1200 may perform one or more processes described herein. Device 1200 may perform these processes in response to processor 1220 executing software instructions stored by a non-transitory computer-readable medium, such as memory 1230 and/or storage component 1240. A computer-readable medium is defined herein as a non-transitory memory device. A memory device includes memory space within a single physical storage device or memory space spread across multiple physical storage devices.

Software instructions may be read into memory 1230 and/or storage component 1240 from another computer-readable medium or from another device via communication interface 1270. When executed, software instructions stored in memory 1230 and/or storage component 1240 may cause processor 1220 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 12 are provided as an example. In practice, device 1200 may include additional components, fewer components, different components, or differently arranged components than those shown in FIG. 12. Additionally, or alternatively, a set of components (e.g., one or more components) of device 1200 may perform one or more functions described as being performed by another set of components of device 1200.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

### Various Aspects of Embodiments

Various further respective aspects and features of embodiments of the present disclosure may be defined by the following items:

Item [1]: An apparatus including: at least one memory storage storing computer-executable instructions; and at least one processor communicatively coupled to the memory storage, wherein the at least one processor may be configured to execute the computer-executable instructions to: present, to a user, a first graphical user interface (GUI) comprising information associated with a service; receive, via the first GUI, a user input for obtaining further information associated with the service; and present, to the user, a second GUI comprising the further information associated with the service.

Item [2]: The apparatus according to item [1], wherein the further information associated with the service may include information of a provider of the service.

Item [3]: The apparatus as according to any one of items [1]-[2], wherein the first GUI may include an interactive element, and wherein the user input may include a user interaction with the interactive element.

Item [4]: The apparatus according to any one of items [2]-[3], wherein the second GUI may include a plurality of block elements, each of which may include a category of information associated with the provider.

Item [5]: The apparatus according to any one of items [1]-[4], wherein the at least one processor may be configured to execute the computer-executable instructions to present the second GUI by: selecting a plurality of information resources; obtaining one or more information from the plurality of information resources; and generating the second GUI based on the one or more information.

Item [6]: The apparatus according to item [5], wherein the at least one processor may be configured to execute the computer-executable instructions to select the plurality of information resources by: determining a plurality of available information resources; and selecting, from the plurality of available information resources, a plurality of optimal information resources.

Item [7]: The apparatus according to any one of items [5]-[6], wherein the at least one processor may be configured to execute the computer-executable instructions to obtain the one or more information by: generating, based on the type of the plurality of information resources, one or more requests; providing the one or more requests to the plurality of information resources; and obtaining, from the plurality of information resources, the one or more information.

Item [8]: The apparatus according to any one of items [5]-[7], wherein the at least one processor may be configured to execute the computer-executable instructions to generate the second GUI by: obtaining a configuration profile defining the configuration of the second GUI; obtaining, based on the configuration profile, one or more information required for generating the second GUI; and generating, based on the configuration profile and the one or more information required, the second GUI.

Item [9]: A method, performed by at least one processor, including: presenting, to a user, a first graphical user interface (GUI) comprising information associated with a service; receiving, via the first GUI, a user input for obtaining further information associated with the service; and presenting, to the user, a second GUI comprising the further information associated with the service.

Item [10]: The method according to item [9], wherein the further information associated with the service may include information of a provider of the service.

Item [11]: The method as according to any one of items [9]-[10], wherein the first GUI may include an interactive element, and wherein the user input may include a user interaction with the interactive element.

Item [12]: The method according to any one of items [10]-[11], wherein the second GUI may include a plurality of block elements, each of which may include a category of information associated with the provider.

Item [13]: The method according to any one of items [9]-[13], wherein the presenting the second GUI may include: selecting a plurality of information resources; obtaining one or more information from the plurality of information resources; and generating the second GUI based on the one or more information.

Item [14]: The method according to item [13], wherein the selecting the plurality of information resources may include: determining a plurality of available information resources; and selecting, from the plurality of available information resources, a plurality of optimal information resources.

Item [15]: The method according to any one of items [13]-[14], wherein the obtaining the one or more information may include: generating, based on the type of the plurality of information resources, one or more requests; providing the one or more requests to the plurality of information resources; and obtaining, from the plurality of information resources, the one or more information.

Item [16]: The method according to any one of items [13]-[15], wherein the generating the second GUI comprises: obtaining a configuration profile defining the configuration of the second GUI; obtaining, based on the configuration profile, one or more information required for generating the second GUI; and generating, based on the configuration profile and the one or more information required, the second GUI.

Item [17]: A non-transitory computer-readable recording medium having recorded thereon instructions executable by at least one processor to cause the at least one processor to perform a method including: presenting, to a user, a first graphical user interface (GUI) comprising information associated with a service; receiving, via the first GUI, a user input for obtaining further information associated with the service; and presenting, to the user, a second GUI comprising the further information associated with the service.

Item [18]: The non-transitory computer-readable recording medium according to item [17], wherein the further information associated with the service may include information of a provider of the service.

Item [19]: The non-transitory computer-readable recording medium according to any one of items [17]-[18], wherein the first GUI may include an interactive element, and wherein the user input may include a user interaction with the interactive element.

Item [20]: The method according to any one of items [18]-[19], wherein the second GUI may include a plurality of block elements, each of which may include a category of information associated with the provider.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. An apparatus comprising:
at least one memory storage storing computer-executable instructions; and
at least one processor communicatively coupled to the memory storage, wherein the at least one processor is configured to execute the computer-executable instructions to:
present, to a user, a first graphical user interface (GUI) comprising information associated with a service;
receive, via the first GUI, a user input for obtaining further information associated with the service; and
present, to the user, a second GUI comprising the further information associated with the service.

2. The apparatus as claimed in claim 1, wherein the further information associated with the service comprises information of a provider of the service.

3. The apparatus as claimed in claim 1, wherein the first GUI comprises an interactive element, and wherein the user input comprises a user interaction with the interactive element.

4. The apparatus as claimed in claim 2, wherein the second GUI comprises a plurality of block elements, each of which is comprising a category of information associated with the provider.

5. The apparatus as claimed in claim 1, wherein the at least one processor is configured to execute the computer-executable instructions to present the second GUI by:
selecting a plurality of information resources;
obtaining one or more information from the plurality of information resources; and
generating the second GUI based on the one or more information.

6. The apparatus as claimed in claim 5, wherein the at least one processor is configured to execute the computer-executable instructions to select the plurality of information resources by:
determining a plurality of available information resources; and
selecting, from the plurality of available information resources, a plurality of optimal information resources.

7. The apparatus as claimed in claim 5, wherein the at least one processor is configured to execute the computer-executable instructions to obtain the one or more information by:
generating, based on the type of the plurality of information resources, one or more requests;
providing the one or more requests to the plurality of information resources; and
obtaining, from the plurality of information resources, the one or more information.

8. The apparatus as claimed in claim 5, wherein the at least one processor is configured to execute the computer-executable instructions to generate the second GUI by:
obtaining a configuration profile defining the configuration of the second GUI;
obtaining, based on the configuration profile, one or more information required for generating the second GUI; and
generating, based on the configuration profile and the one or more information required, the second GUI.

9. A method, performed by at least one processor, comprising:
presenting, to a user, a first graphical user interface (GUI) comprising information associated with a service;
receiving, via the first GUI, a user input for obtaining further information associated with the service; and
presenting, to the user, a second GUI comprising the further information associated with the service.

10. The method as claimed in claim 9, wherein the further information associated with the service comprises information of a provider of the service.

11. The method as claimed in claim 9, wherein the first GUI comprises an interactive element, and wherein the user input comprises a user interaction with the interactive element.

12. The method as claimed in claim 10, wherein the second GUI comprises a plurality of block elements, each of which is comprising a category of information associated with the provider.

13. The method as claimed in claim 9, wherein the presenting the second GUI comprises:
selecting a plurality of information resources;
obtaining one or more information from the plurality of information resources; and
generating the second GUI based on the one or more information.

14. The method as claimed in claim 13, wherein the selecting the plurality of information resources comprises:
determining a plurality of available information resources; and
selecting, from the plurality of available information resources, a plurality of optimal information resources.

15. The method as claimed in claim 13, wherein the obtaining the one or more information comprises:
generating, based on the type of the plurality of information resources, one or more requests;
providing the one or more requests to the plurality of information resources; and
obtaining, from the plurality of information resources, the one or more information.

16. The method as claimed in claim 13, wherein the generating the second GUI comprises:
obtaining a configuration profile defining the configuration of the second GUI;
obtaining, based on the configuration profile, one or more information required for generating the second GUI; and
generating, based on the configuration profile and the one or more information required, the second GUI.

17. A non-transitory computer-readable recording medium having recorded thereon instructions executable by at least one processor to cause the at least one processor to perform a method comprising:
presenting, to a user, a first graphical user interface (GUI) comprising information associated with a service;
receiving, via the first GUI, a user input for obtaining further information associated with the service; and
presenting, to the user, a second GUI comprising the further information associated with the service.

18. The non-transitory computer-readable recording medium as claimed in claim 17, wherein the further information associated with the service comprises information of a provider of the service.

19. The non-transitory computer-readable recording medium as claimed in claim 17, wherein the first GUI comprises an interactive element, and wherein the user input comprises a user interaction with the interactive element.

20. The non-transitory computer-readable recording medium as claimed in claim 18, wherein the second GUI comprises a plurality of block elements, each of which is comprising a category of information associated with the provider.
